(19) United States
(12) Patent Application Publication
(10) Pub. No.: US 2005/0201360 A1
(43) Pub. Date: Sep. 15, 2005

(54) Network radio-device and system for audio listening and broadcasting using a real-time transmission

(76) Inventor: Douglas E. Redstone, San Diego, CA (US)

Correspondence Address: DOUGLAS E. REDSTONE, 10393 GOLD COAST PLACE, SAN DIEGO, CA, 92126, US

(21) Appl. No.: 11/001,150

(22) Filed: Nov. 30, 2004

Related U.S. Application Data
(60) Provisional application No. 60/551,456, filed on Mar. 9, 2004.

(51) Int. Cl. H04L 12/66

(52) U.S. Cl. 370/352

(57) ABSTRACT

A device called a “Network Radio” for selecting, listening, and broadcasting real-time audio content and content in digital format to assist or enhance the real-time audio content; and a system comprising of the Network Radio, a wireless radio frequency network (cell/wi-fi), and a computer server or servers for managing, receiving and transmitting real-time content. After a station is selected, if the Network Radio's current function is for listening, the server initiates a real-time transmission of the requested audio. Once the device receives the transmitted audio it may process the real-time broadcast for better quality sound or decoding and for immediate audio output to the amplifier and speaker for the listener. If the device's current function is for broadcasting, then the device transmits the audio through the network to the server and the server initiates transmission to other devices whose current function is for listening and have requested the broadcasting station.

### FIELD OF INVENTION

This invention relates generally to the field of traditional AM/FM radio broadcast and consumer devices for listening to audio broadcasts and other devices and systems for broadcasting audio.

### BACKGROUND

This invention also relates to internet radio stations that use audio streaming and other software to broadcast/transmit audio. Satellite radio also transmits audio content to listeners. Furthermore, the invention relates to portable phones, cell phones, wi-fi phones and other wireless devices capable of connecting to a wi-fi/cell network. The invention also relates, in part but not essential, to tape playing and recording electronics, cd players, MP3 and other digital audio players, and other devices capable of storing audio for playback. Specifically, U.S. Pat. No. 6,212,555 is a recent patent for storage and playback that uses wireless methods of transfer for storage.

It is well known that traditional AM/FM radio is one of most common methods of providing a consumer with a selection of audio programming. In today's world, you can drive from city to city and go from country to country and use a traditional AM/FM radio to hear public broadcasts. However, once you leave the range of that station's signal you cannot receive the station's broadcast, limiting the range of the station to a geographical region unless you use the internet to receive the same broadcast.

We now have cell networks and wi-fi networks that breakthrough these AM/FM ranges. With mobile phones and PDAs that utilize RF technology you can reach and talk from country to country and from region to region. With an invention that uses wi-fi/cell networks that can reach globally, the listener may be traveling on to another state or another country and will be able to listen to broadcasts from traditional AM/FM radio stations from his/her home town or another region.

Listeners can already do this with a computer and internet connection, however, a simple device similar to a mobile phone is needed that does not have the complications of a personal computer. With a new device where the user only needs to turn the power on and select a station users will be given more opportunity for varied content. A convenient device is needed that eliminates the need for computer boot-up, program selection, and complications of having many tasks to choose from. Also, traveling with a portable one-function device is easier than traveling with a computer. This portability can also be transferred to automobiles and other vehicles.

Today, some technology uses “streaming” as a means to transfer audio and visual data requiring software and hardware designed for such a purpose. A device that uses similar technology specifically designed for a single purpose would allow for real-time broadcast of already existing streamed content.

A new device that coordinates a network of regional stations will also create opportunity for new broadcasts and for live broadcast of events. Categories of these stations may include professional sports, amateur and children's sports, talk radio, religious groups, support groups, music categories, special events such as weddings, etc.

Again, the use of a server technology and wireless network technology will allow the user to design his own radio station where he can load the audio files to a server from a PC or other capable devices and schedule the time and day for playback. He can also repeat the selections, essentiality creating his own radio station. Today, portable storage devices are limited by the amount of information they themselves can store, where the only limitation of the proposed invention is the amount of information the server can store. The industry has already created consumer products and software making it easy for purchasing and downloading music on computers and other devices for enhanced user control. This same technology will make it easier for people to broadcast there own choices when given a station and a registration process to do so. A recent U.S. Pat. No. 6,212,555 uses wireless means for audio transfer to store audio like other digital storage devices such as mp3 players and iPods. However, storage of audio on these devices is essential for playback and this storage method may be incorporated as an option for a new device. A new invention that utilizes far-reaching RF networks will eliminate the need for immediate decision by the user. Traditional AM/FM broadcasts offer something that digital recording devices do not. That is, someone choosing the content, giving the broadcaster an opportunity to provide a service and live voices of music hosts. Actually, with a new invention, the user will have both types of technology—one where the listener is in control of the content and one where someone has decided the content for the listener. All from the same device. It is well understood that phone conversations which use RF technology across cell/wi-fi networks are getting better in quality. Just as two people speak to each other in a phone conversation on a RF network in real-time, so can other audio content be sent through the same networks to a device designed for such a use.

With the internet and cell/wi-fi networks we have seen the need businesses have for reaching consumers and employees. With the internet we have seen the need people have for reaching family and friends, and the need governments have to contact their employees and their people and of course the need for people to contact their governments. With the internet and cell/wi-fi networks we have also seen the joy that technology can bring. Unfortunately these new technologies have also been blamed for some harm. Traditional audio broadcasts are limited by region and have limited variety and so do not accommodate for a growing population and a technology industry. However, considering the knowledge and experiences coming from these and other technologies and considering the freedoms cultivated by them, a new convenient device that decreases the over-abundance of choices on the internet but increases opportunity for people and organizations to enjoy audio content and share their audio experiences will allow listeners to hear what they otherwise would not hear, broadcasters the opportunity to provide a service they would otherwise not be able to provide, and many people and organizations to share events they would otherwise not be able to share.

### SUMMARY

A device (this device will be referred to as “Network Radio”) for selecting, listening and broadcasting audio content and content in digital format to assist or enhance the audio content; and a system comprising of the Network Radio, a wireless radio frequency (RF) network, and a computer server or servers for initiating transmission and reception of the content. Specifically, the network is a wi-fi/cell network. There is a control on the network radio that determines the current function. Simply, this control is set to “listening” or “broadcasting”.

The network radio can be a stand alone device that is portable or part of a larger audio system. The network radio can also be used with other audio equipment compatible with the network radio and it can it be installed in automobiles and other vehicles.

Station Selecting: The Network Radio transmits a single station selection that has been chosen for listening or broadcasting audio content and other information assisting or enhancing the audio. The transmission is received by the server after going through the cell/wi-fi network. Different levels of selection information can be used to select a single station. The first level of selection contains two very distinct types of audio selections. These two levels of selection can be shown on one or more displays or a combination of a display(s) and other types of controls. These two types of levels are, one, the user's personal stations that he has created for private use and, two, different geographical regional choices that are for public use.

After the user has selected, on the first level, his personalized private stations, the stations are displayed. The user can then select from his personalized stations. If the user has selected regional public stations on the first level, the choices are then arranged by category in that region. Then a choice for category is made. After the first two levels are chosen, a list of stations for the chosen region and category is displayed on the same or another display. When a new region and/or new category is chosen, a new list of choices is displayed. The content of the selections—the list of stations—is either taken from a larger list/database stored on the Network Radio or from a received transmission stored on the server.

There is also a way of selecting a station directly without selecting a region or category. The user has the option of selecting a known station by typing the corresponding information on a keypad that is hidden so not to complicate the user interface. This keypad can be of letters, numbers, symbols and any combination thereof. The user can also select and transmit with voice commands or another known method.

Selection transmission: The station selection—the choice—is then transmitted by touchtone, modem, or another known method of existing technology using RF (radio frequency) technology of the Network Radio to a cell/wi-fi network. In turn, the selection is received by a specialized server that is capable of receiving this selection. In general, the Network Radio uses any RF technology capable of communicating with a wireless cell/wi-fi network. This RF technology is either an internal component of the Network Radio or the Network Radio is connected to another separate device (such as a cell phone, wi-fi phone, or pda) that has RF technology capable of connecting to a cell/wi-fi network. This will be referred to as an “external RF device.” If the Network Radio does not have working RF technology, the external RF device assists the Network Radio in establishing a connection to the wi-fi/cell network and, in turn, the server.

If the Network Radio uses an external RF device capable of communicating with a cell/wi-fi network, the Network Radio is connected by wire to the external RF device, or wireless technology (such as blue tooth) to either a headset jack of a cell phone, wi-fi phone or pda or another port of a cell phone, wi-fi phone or pda. If the Network Radio's connection to the external device is through the headset jack, than the user of the Network Radio will have manually called/connected to the server with the cell phone. If the Network Radio is connected to the external device through another method such as a data port, then the Network Radio may initiate the external device to dial/connect to the server automatically using software.

Listening to audio content transmitted from the server: If the Network Radio's current function is for listening, the server initiates a real-time transmission of the requested audio content through the wireless network to the Network Radio according to the selection sent from the Network Radio. The audio content may be in digital or analogue format.

The audio content for listening is transmitted in “real-time” to the Network Radios by the server as with common AM/FM radio transmissions. Once a Network Radio receives the transmitted audio it may process the real-time broadcast for better quality sound and/or decoding for audio output to the amplifier and speaker for the listener. The user may also attach speakers using industry standard output connections. Depending on the content, there may be another delay at the broadcasting source or the server for content monitoring according to current law. The Network Radio's conversion to analogue sound for amplifier and speakers is only limited by the speed of transfer of information on the cell/wi-fi network as with a phone conversation on the same type of networks.

The first level of selection contains two very distinct types of audio. These two types are, one, the user's personal stations that he has created for private use and, two, different geographical regional choices. The first type, personal stations, is stored programming where the user has previously loaded the content to the server from a personal computer, PDA, another device capable of uploading audio files to the server, or a Network Radio. Both personal stations and regional stations will be broadcast in the same way, real-time from the server. For both types, this real-time broadcast can be a scheduled broadcast, a broadcast that is constant, or the real-time broadcast can be requested from the Network Radio device and not to be transmitted until then.

If the user has not selected his personal stations, he selects a region. Regional selections contain content that only passes through the server. This content originates from an outside source goes to the server. The server initiates a broadcast in real-time. Furthermore, the audio content for listening is a live or externally stored real-time transmission and constantly passing through the server or a real-time transmission that has been requested or scheduled for a specific day and time. The server's main function is to coordinate and connect the audio requested with the Network Radio that has selected that audio; and to transmit the necessary information for the broadcast.

Once the Network Radio receives the transmitted audio it may process the real-time broadcast for better quality sound and/or decoding and for audio output to the amplifier and speaker for the listener. The user may also attach speakers using industry standard output connections. Depending on the content, there may be another delay at the broadcasting source or the server for content monitoring according to current law.

Broadcasting from a Network. Radio: If the Network Radio's current function is for broadcasting and has been assigned a broadcasting region, category, and station name, then the Network Radio transmits the audio through the network to the server and the server will initiate transmission to other Network Radios whose current function is for listening and have requested that station whose broadcast corresponds to the original Network Radio's broadcasting station. Using industry standard inputs, the broadcast can contain content from other devices and systems. Examples of these devices and systems are computers, cd players, tape decks, digital music storage devices, and microphones.

Content: The audio content can be enhanced by other information, specifically, text, still picture, and video. However, the audio content is the primary function of the system and Network Radio device. The first level of selection contains two very distinct types of audio content. These two types are, one, the user's personal stations that he has created for private use, two, different geographical regional choices that are for public use. The transmissions are in real-time so that the broadcasting content is heard at the listening end at the same time or almost at the same time depending on the type of broadcast content and the speed of the network.

Regional Choices: The regional content originates from an outside source, passes through the server, and the server initiates the broadcast to the cell/wi-fi network that, in turn, transmits to a Network Radio. Generally, the regional content is any audio content such as traditional AM/FM broadcasts, internet radio, and new broadcasts that originate from any device capable of connecting to the server and has been assigned a broadcasting station, region, and category.

These devices used for transmitting content to the server may include but are not limited to personal computers, PDAs, cell phones, wi-fi phones, house phones, another Network Radio, cd players, full sound systems, and other sound equipment capable of connecting to a Network Radio or the server by internet, wi/fi-cell network or another known method.

Specifically, the regional content is a real-time broadcast of music, talk, sports, audio books, content specific such as history science, movies, audio media, infomercials, private events such as celebrations and meetings, speakers, government events and broadcasts, support groups, etc. This external content that passes through the server can be live or recorded, depending on the choice of the broadcaster.

Personalized Content: If the personalized content is stored for real-time broadcast it will begin to broadcast at a scheduled day and time or when requested/connected. The personalized content is a user's personal stations that is stored on server. The content can be loaded through a website from a personal computer, pda, or other device set up to communicate to the server by uploading audio content. Essentially, the user can create his own radio stations and will have a chance to name his station. These stations can be for different uses or have different content. Examples of these uses can be “My Office Music”, “My Exercise Music”, or “My Social Music”. Different types of music can be “My Pop Music” or “My Music Mix”. The user has multiple stations that are displayed when he chooses his personalized content.

Other existing technology and audio manipulation: After the content has been processed for quality and converted for analogue output, the content can be directed to other devices and systems that are compatible using industry standard output connections. Also, after the content has been processed for quality and conversion it may be stored using known stationary and known removable storage device. This storage is not essential for the Network Radio functions. These methods of storage include but are not limited to CDs, MP3, tape, and other digital and non-digital storage methods and devices. The user of the Network Radio can manipulate transmitted content with corresponding controls such as, but not limited to, pause, play/continue, stop, forward, and rewind.

### BRIEF DESCRIPTION OF DRAWINGS AND KEY

FIG. 1—are detailed diagrams of the device and components of the device

FIG. 1a —is a diagram of the device with internal radio frequency technology

FIG. 1b—is a diagram of the device with internal radio frequency technology and has labels for components

FIG. 1c—is a diagram of the device attached to an external RF technology device

FIG. 1d—is a diagram of the device with internal radio frequency technology and speakers

FIG. 1d—is a diagram of the device with internal radio frequency technology, speakers and a cd player.

FIG. 2—are diagrams of the system containing device(s), server(s), and a network(s)

FIG. 2a—is an overview of the system from broadcast of audio content to listening of audio content

FIG. 2b—is an overview of the listening function of the system

FIG. 2c—is an overview of the broadcasting function of the system

FIG. 3—device and system essentials and different versions device and system

FIG. 3a—is an overview of the station selection method

FIG. 3b—is and overview of the essential device components

FIG. 3c—is an overview of the software version essential components and device with one display.

### DRAWINGS KEY

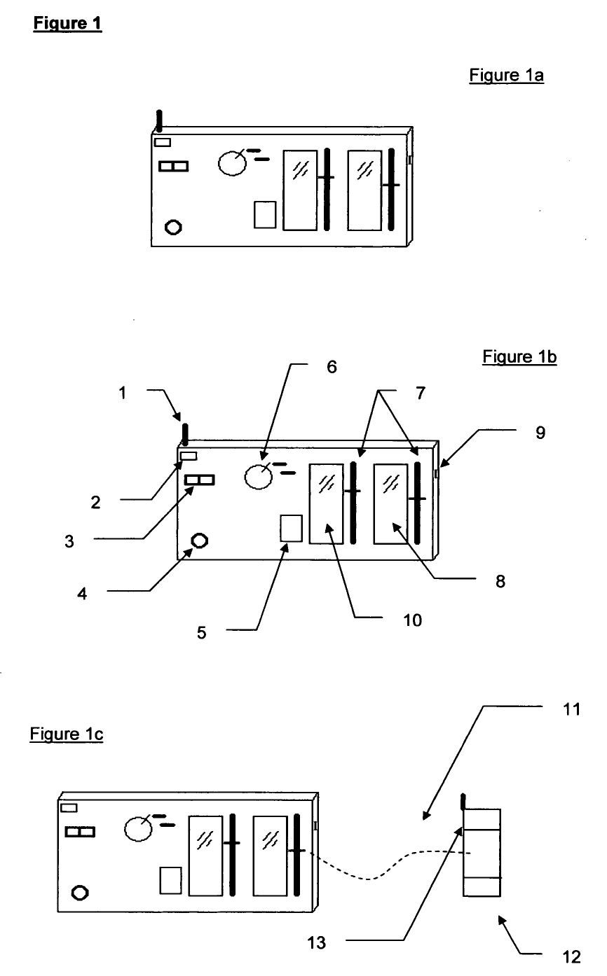

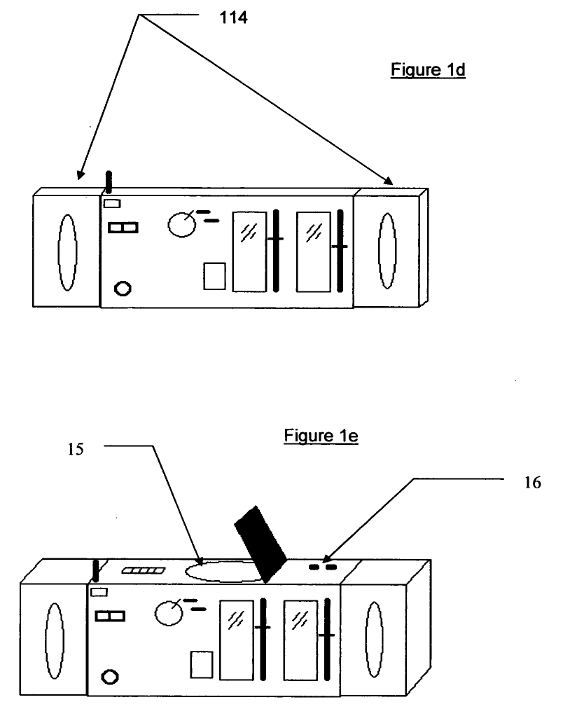

FIG. 1b—is a diagram of the device with internal radio frequency technology and has labels for components
1. cell/wi-fi radio frequency antenna attached to corresponding internal components
2. power control
3. function control—listening/broadcasting
4. volume control(s)
5. direct station dial
6. level 1 selection control—regional/private
7. level 2 and 3 selection controls
8. station selection display
9. inputs and outputs—connection to external RF technology
10. category selection display

FIG. 1c—is a diagram of the device attached to a cell/wi-fi phone used as an external radio frequency device
11. Connection from device to external RF device
12. External RF device (cell/wi-fi phone)
13. port of external RF device—headset jack or other port

FIG. 1d—is a diagram of the device with internal radio frequency technology and speakers
14. speakers

FIG. 1e—is a diagram of the device with internal radio frequency technology, speakers and a cd player.
15. cd player
16. industry standard audio inputs and outputs

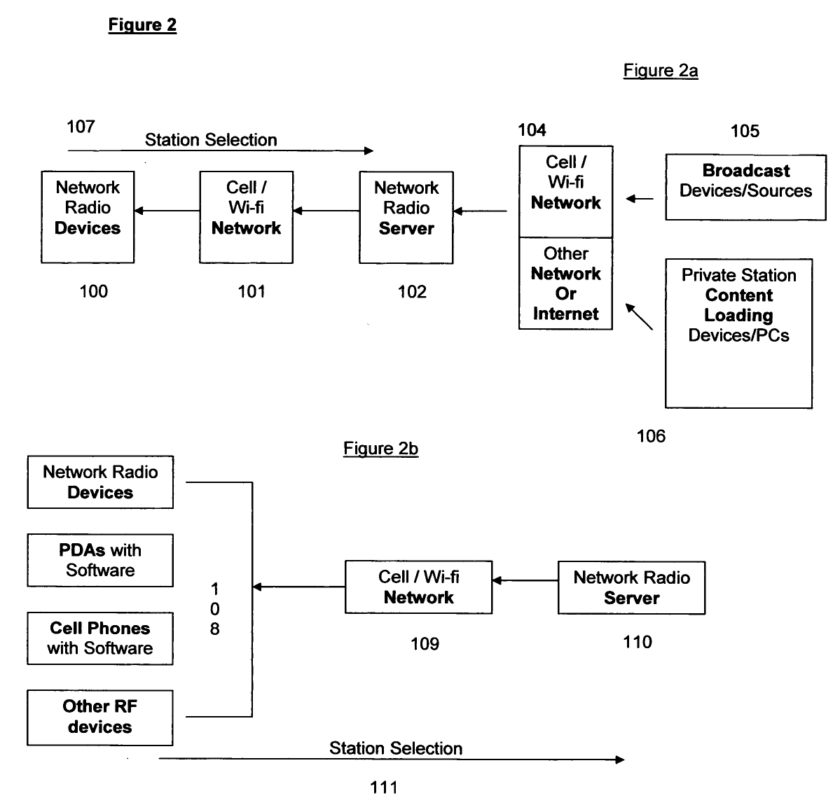

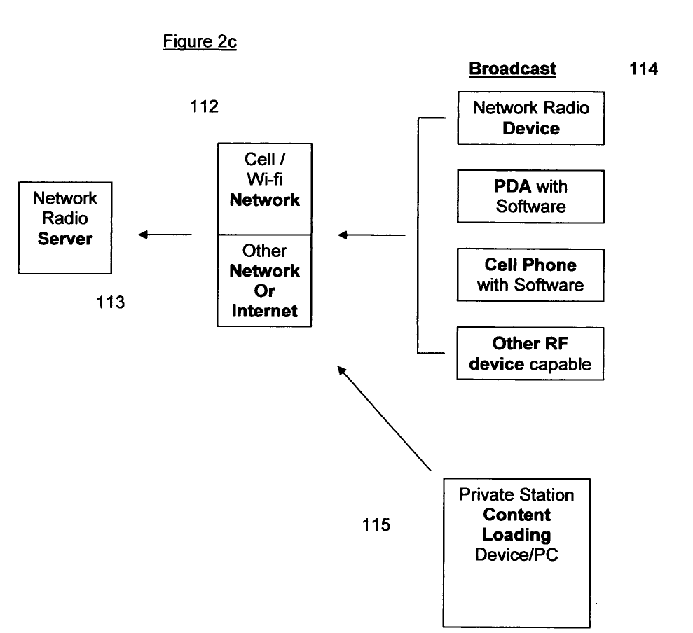

FIG. 2—are diagrams of the system containing device(s), server(s), and a network(s)

FIG. 2a—is an overview of the system from broadcast of audio content to listening of audio content
107. devices
108. cell/wi-fi network/other network/internet
109. server
110. cell/wi-fi network/other network/internet
111. broadcast sources
112. private station loading—device/personal computer
113. station selection

FIG. 2b—is an overview of the listening function of the system
114. server
115. network
116. plurality of listening devices
117. station selection

FIG. 2c—is an overview of the broadcasting function of the system
118. plurality of broadcasting devices
119. cell/wi-fi network/other network/internet
120. server
121. device, PC—Private station content loading

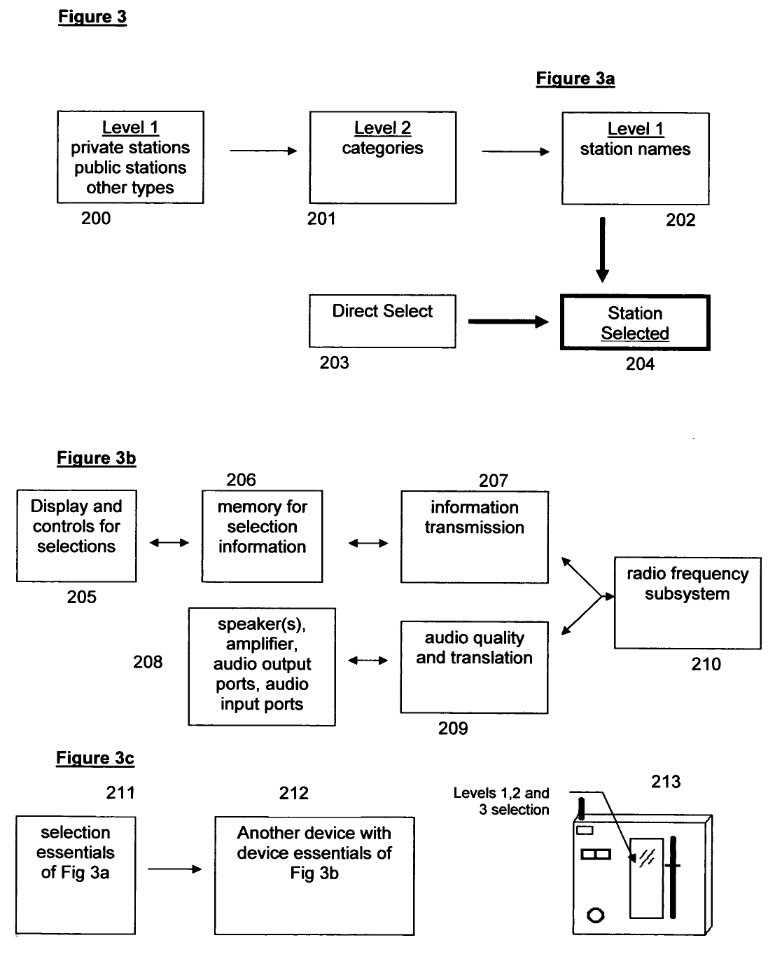

FIG. 3—are other overviews of the system, device, and its functions

FIG. 3a—is an overview of the station selection method
200. level 1 selection
201. level 2 selection
202. level 3 selection
203. direct selection
204. selection

FIG. 3b-essential components of the Network Radio (device)
205. displays and controls for selections
206. memory for selection information
207. transmission components
208. audio quality and translation components
209. radio frequency subsystem

FIG. 3c-different versions of the proposed device and system
210. software essentials
211. another device with RF technology
212. Network Radio with one display

### DETAILED DESCRIPTION OF DRAWINGS

Generally, the device (this device will be referred to as “Network Radio”) is for selecting, listening and broadcasting audio content and content in digital format to assist or enhance the audio content; and has a system comprising of the Network Radio, a wireless radio frequency (RF) network, and a computer server or servers for initiating transmission and reception of content.

First, in FIG. 1b: the antenna (1) is part of the Network Radio's radio frequency (RF) subsystem (FIG. 3b-210) and the other components of RF subsystem are housed within the device. When the power is turned on (2) the Network Radio is connected to a RF network that it is capable of communicating with a managing server and therefore, the Network Radio is also connected to that server. Specifically, this is a wi-fi, cell or other known RF network (FIG. 2c-212). This is similar to turning on the power of a common cell/wi-fi/mobile phone and dialing or turning on the power of a pda and connecting to a particular server.

The Network Radio has two distinct functions, listening and broadcasting, that can be controlled by the user. These functions are determined by control 3 in FIG. 1b. If the function control (3) is set to “listening”, when the power is turned on, the displays (8, 10) are populated with information for the user to make a selection of audio content with the controls for that function (7). The user can also make an audio station selection directly with a keypad (5) or other known method. The first level control (6) is used to select regional public stations or private listening stations or other options on this first level of selection. After the listener has made a selection, the selection is sent by touchtone, modem or another known method with RF technology to a managing server (FIG. 2a-107, 2b-111) and the server initiates transmission of the selected audio content back to the Network Radio, again, through the network in real-time. As with a phone conversation, the server is “speaking” to the listener's Network Radio in real-time or the server is coordinating and directing real-time content to Network Radio's and devices capable of receiving transmissions from the Network Radio server. If a selection change is made on any of the levels (6, 10, 8) using controls for this function (6,7), then corresponding information is displayed and the new selection is sent to the server through the network. The controls for changing selections can be any known control or method for making selections on displays, including 1 display as with in FIG. 3c-213 or multiple displays as in FIG. 1. The data for the stations is stored in memory of the device (FIG. 3b-206) and/or on the managing server (FIG. 2a-102) and sent to the Network Radio. When the real-time audio content is received by the Network Radio it may be processed for sound quality (FIG. 3b-209). Once the audio is processed for sound quality, it can be heard through speakers (FIG. 1d-114) or other devices or systems capable of receiving audio input from the Network Radio using standard industry connections and ports (FIG. 1e-16).

Referring again to fig 1b: If the function control (3) is set to “broadcasting”, when the power is turned on, the displays (8, 10) are populated with information identifying the user's registered broadcasting station(s). As with listening, the user can also make a selection directly by using a keypad (5) or other known method. The same methods of station selection used for listening are used for broadcasting. Security will also incorporate these and other known and unknown methods. Once a broadcasting connection has been established with the managing server (FIG. 2c-113, FIG. 2b-110) through the network (FIG. 2c-112) from the Network Radio, audio content is broadcasted from the Network Radio to other Network Radios who's current function is set to listening (FIG. 2b-108), have the corresponding station selected, and also have a connection established to the managing server. Again, this is similar to a cell/wi-fi/mobile phone conversation in real-time where the person talking is the broadcaster and a plurality of listeners is on the other end. FIG. 1e shows how broadcasting content can be sent using the Network Radio. A broadcaster can use a cd player (FIG. 1e-15) that is a component of the Network Radio or can use other devices/systems capable of connecting to the Network Radio using industry standard inputs (1e-16). Examples of these devices and systems are computers, cd players, tape decks, digital music storage devices, and microphones. Devices that have the broadcasting station selected will be “listening” to the audio in real-time that has gone through the server in order to establish connections properly. The only difference in time between the content being broadcasted and the content that has become analogue on the “listening end” is the processing of the network(s) in between, the processing of the server, and the processing of the Network Radio.

FIG. 1c: If the Network Radio contains non-functioning RF technology or does not contain RF technology it can be connected to any external device (12) that has RF technology capable communicating with the cell/wi-fi network. FIG. 1c shows a common cell/mobile/wi-fi phone for this purpose. This connection (11) can be wire or wireless known methods. The connection to the external RF device (13) can be to an industry standard headset jack or another type of port or connection capable of maintaining the functions of the Network Radio. If the connection does not enable the Network Radio to initiate dialing/connecting of the external device, then the user must dial/connect to the network and server manually according to the external RF device's method, such as dialing a mobile phone. When a Network Radio is connected to the server through the network, a selection can be made and audio content can be transmitted.

FIG. 2a shows the components of the Network Radio system from broadcasting to listening. Audio content is transmitted from a plurality of broadcasting devices (105,106, also FIG. 2c-114) to the RF network or another network/internet (104) and to the managing server (102). This content is live/real-time to the listener, although it may be recorded by the broadcaster. Broadcasting content can also be loaded to the server through an internet connection (104) from a PC, PDA or another device capable of establishing a connection to the server (FIG. 2c-114).

Still looking at FIG. 2a, the content is directed to the Network Radio devices (100) whose listening selection corresponds to a particular broadcasting station through the cell/wi-fi network (101). In FIG. 2b, the plurality of listening devices is shown (102). The transmission of the content going to the devices is transmitted in real-time. Therefore, the content on devices that have the same station selected is the same, as with common AM/FM broadcasts. However, using software and managing technology, the broadcaster may choose to begin a broadcast only upon connection to his broadcasting station, thereby, making the same content occur at different time on a plurality of devices. In either case, the server initiates transmission to the plurality of Network Radio devices and the audio is heard after being processed for quality and decoding and for analogue ouput.

FIG. 2c shows the plurality of devices that can broadcast audio content to the server that coordinates connections (113) to listening devices (FIG. 2b-108).

FIG. 3a shows the method of selecting a station. The user makes a selection on at least two levels. FIG. 3a shows three levels of selections. First, private or public regional stations are selected (200). Private regional stations are stations that have been created for the user of that particular device. The user will have loaded content through a pda web connection or pc web connection and scheduled his station for broadcasting or to broadcast when requested. Public stations are stations such as internet radio stations, common AM/FM broadcasts and other new broadcasts.

After a choice is made on level 1, the corresponding categories are displayed (201). Using the two selections, on levels 1 and 2, station names are displayed and a choice is made on level 3. The selection (204) is then sent to the server. These levels of selections can be on any number of screens or controls or combination thereof as in FIG. 3c-213 where there is only one display to accomplish the same.

FIG. 3b shows the essential components of the Network Radio device that have already been described.

FIG. 3c shows the device and system in a software version for internet use and use on another device. The same essential components are there for selection, broadcasting, listening and connecting to the network as in FIG. 2a-101. This other device with a software version (3c-211) would be a device of the pluralities in FIG. 2b-108 and 2c-114.

The Network Radio can also incorporate other known technologies for volume control, recording, playback and other manipulation of audio content.

1. System: a system and device for listening and broadcasting audio content wherein said system:
a. comprises of a device or plurality of devices, a wireless radio frequency network, and one or more servers
b. uses a device that has a control to set the current function of the said device to broadcasting or listening
c. contains a cell/wi-fi network whose purpose is to transmit and receive real-time audio between said device and said server
d. contains another type of network such as house phone, ground line, etc. that is capable of communicating with said server.
e. contains another type of RF network other than cell/wi-fi that is not currently open for commercial use
f. uses a combination of the said types of networks in claim 1
g. contains a computer server or servers for managing, receiving, and transmitting content or initiating content to transmitting technology
h. can be in a form of software and another known device capable of filling functions of said device
i. uses a real-time transmission that is defined as:
i. a situation where the receiving device receives a transmission from a broadcasting source instantaneously or almost instantaneously only decreased, increased, or limited by the hardware and software between the broadcasting source and the receiving device.
ii. a situation similar to a known phone or known mobile phone conversation.
iii. a situation that uses known technology known as audio-streaming, wherein software is used at the broadcasting source and at the receiving device or system to prepare the content for immediate or almost immediate analogue output regardless of length of content.

2. Device: a device for selecting, listening, and broadcasting audio content and content in digital format to assist or enhance the audio content wherein said device:
a. is for selecting a single audio station for listening or broadcasting and has a control for this purpose
b. uses a known radio frequency (RF) subsystem to transmit and receive audio from a wireless network
c. contains known internal radio frequency hardware and software technology capable of transmitting to and receiving from a cell/wi-fi network.
d. contains known RF technology in mobile phones and PDA devices
e. uses wire or wireless technology to connect to another device that contains known internal radio frequency hardware and software technology capable of transmitting to and receiving from a cell/wi-fi network.
f. contains a control or embedded or non-embedded software for determining a function of the said device as listening or broadcasting
g. has standard industry inputs and outputs for audio content
h. uses wire or wireless technology as a connection to another device (an external RF device) that contains internal radio frequency (RF) hardware and software technology capable of transmitting to and receiving from a cell/wi-fi network:
i. said attached external RF device is connected to a headset jack of a cell phone, pda, or other device capable of transmitting to and receiving from a cell/wi-fi network
ii. said attached external RF device is connected to another port of a cell phone, pda, or other device capable of transmitting to and receiving from a cell/wi-fi network
iii. said connection is to another port and uses software to communicate with external device
iv. said connection is wire or wireless such as blue-tooth
v. said device uses other means as a replacement for the cell/wi-fi network for same function of claim 3
1. said device is connected to a headset jack of a portable ground line phone to accomplish the same of claim 2-h
i. said device is for selecting a single audio station for listening or broadcasting wherein said selection:
i. is made using controls for said selecting method of claim 2-i, j, and k
ii. is sent by modem, touchtone or another known method with existing technology using said RF subsystem of claim 2-b to a cell/wi-fi network and then to said server of claim 4.
iii. needs to have a current function of listening to have requested audio sent back to said device in real-time
iv. needs to have a current function of broadcasting and server initiates re-transmission of audio to said plurality of devices through network(s) of claim
j. said device is for selecting and listening to public stations wherein said device:
i. has a combination of controls and displays to achieve selecting method of claim 2-i
ii. contains one level of selections
iii. contains two levels of selections for each station;
iv. contains three levels of selection for each station: one level is a region, another category, and another name
v. contains three or more levels of selections of any type
vi. contains controls and displays that interact with each other to achieve a station selection of claim 2-i
vii. contains one display for three levels or more to choose from
viii. contains three displays for three levels to choose from
ix. contains at least one display for three levels of choice
x. has a selection that is sent by modem, touchtone or another method with said RF technology to a cell/wi-fi network and then to server of claim 4
xi. receives audio in real-time from server of claim 4
xii. contains controls for selecting a station directly using method of claim 2-L
k. said device is for selecting and listening to private stations wherein:
i. the content has been created by loading audio files through a website on a personal computer, pda, or another device; or a private station has been created by establishing a connection to another broadcasting station via the same website.
ii. a selection is sent by modem, touchtone or another method with existing technology using RF technology to cell/wi-fi network and then to server.
iii. a selection is received by a server and the requested audio's transmission is initiated and transmitted to said device in real-time according to said claim 1-h and or decoded.
iv. said device receives the transmitted audio and it is processed the real-time for better quality sound and for audio output to the amplifier and speaker for the listener using known hardware, software and micro processors
v. said device has outputs for speakers or other output devices
l. said device is for selecting a station directly without using categories and levels of claims 2-j and 2-k wherein said device:
i. has current function set to listening or broadcasting
ii. has keypad to select a station by typing the identifying number, letters, or symbols
iii. has a selection that is sent by modem, touchtone or another method with said RF technology to a cell/wi-fi network and then to said server
iv. has other known methods and technology for selection.
m. said device is for broadcasting audio content wherein said device:
i. has multiple broadcasting stations displayed on said device.
ii. is identified for broadcasting, broadcasting station(s) is identified by and selected according to said method of claim 2-i
iii. has audio inputs for additional devices and systems for broadcasting
iv. uses known technology such as, but no limited to, a CD player, tape deck, or microphone or the mentioned is a component(s) of said device for broadcasting
v. processes broadcasting content for quality and decoding using known hardware, software and micro processors
vi. transmits audio content to server using known RF technology

3. Network: said system contains a network whose purpose is to transmit and receive real-time audio between plurality of said devices and said server, wherein said network:
a. is a wireless radio frequency (RF) network whose function is to connect to server
i. said wireless RF network is a known cell network
ii. said wireless RF network is a known wi-fi network
iii. existing RF network opened for public use in the future
b. is a wire network whose function is to connect to said server
i. said wire network is a known phone line using internet
ii. said wire network is a known phone line using cable
iii. said wire network is a known phone line using standard ground line
iv. said wire network is other known phone line

4. Server: said system contains a computer server or servers for managing, receiving, and transmitting content wherein said server(s).
a. is to manage and organize station selections that are displayed on said device.
b. uses hardware and software to initiate transmission and coordinate transmission in real-time programming of said claim 1 to plurality of said devices
c. receives transmission of broadcast from said devices from said network; and said server re-transmits audio content to plurality of said devices through said network
d. receives transmission of broadcasts through internet and other known sources capable of communicating with server
e. stores content and transmits real-time content of said claim 1

5. Content: audio content and content in digital format to assist and enhance audio content, wherein said content:
a. uses a real-time transmission from system of claim 1-i
b. has identifying information that is stored on said server of claim 4 or said device of claim 2 and listed on displays of same
c. public or private, of claim 2-j,2-k and is selected using said method of selection of same claim
d. is from a selection that is sent by modem, touchtone or another method with said RF technology to a cell/wi-fi network and then to said server
e. is from a server that initiates transmission of content according to selection
f. is transmitted to said plurality of devices through cell/wi-fi network, wherein:
i. said transmitted content contains real-time audio; content contains real-time digitial audio; content contains real-time analogue audio, wherein said audio content:
1. is from a source outside of server
2. is live from a source outside of server
3. has been recorded and is from a source outside of server
4. stored on said server
5. is broadcasted by server regardless if requested or not
6. is broadcasted by server when requested
7. is scheduled for broadcast
ii. other content is sent to assisvenhance the audio content and device, said content is:
1. video
2. picture
3. text
4. other content in digital format.
g. said content choices include existing broadcasts such as AM/FM and internet radio
h. said content includes new broadcasts
i. said content includes but is not limited to music, talk, sports, audio books, content specific such as science, movies, audio media, info-mercials, private events such as celebration and meetings, speakers, government events and broadcasts, supports groups

6. said device uses other known technology and patents, wherein said device:
a. uses known technology for stationary storage of received audio content such as U.S. Pat. No. 6,212,555, MP3 and other known digital and non-digital storage methods
b. uses known removable storage devices and components such as other patents, tapes, CDs, and other known removable storage devices
c. has real-time content that is processed for quality and decoding of claim (2-k-iv, 2-j) then content is directed for analogue audio output and then content is stored according to storing method of the said device.
d. has real-time content that is processed for quality of claim (2-k-iv, 2-j), the content is directed for analogue audio output and the content is simultaneously stored according to storing method of the said device.
e. upon receiving the content the user has already chosen to store the content, after said content is processed for quality of claim (2-k-iv, 2-j) the content is stored according to storing method of said device and simultaneously directed for analogue output
f. has controls for manipulation of transmitted content that include, but are not limited to pause, play/continue, stop, forward, and rewind.

7. said device has modifications for use in different modalities
a. said device can be installed in automobiles and other vehicles known and unknown
b. said device can be used as a standalone device portable or larger

8. said device can be used for broadcasting and listening simultaneously for related functions, wherein related functions are but not limited to:
a. large conferences and meetings
b. simultaneous vocal and instrumental play
c. group discussions

9. said device and system can be changed to have video, real and unreal, as the primary function for the user for both listening and broadcasting, wherein said device:
a. is a future patent or provisional patent of said inventor
b. is another function of the Network Radio patent of said inventor
c. is a software version of claim 1-h on another known RF device
d. contains other content to assist/enhance the video content and device, wherein said content is:
i. audio
ii. other content in digital format.
iii. still picture
iv. text
